(19) United States
(12) Patent Application Publication
(10) Pub. No.: US 2011/0170050 A1
(43) Pub. Date: Jul. 14, 2011

(54) LOCKING BRIDGE

(76) Inventor: Daniel Eduardo Berdou, Buenos Aires (AR)

(21) Appl. No.: 12/998,125

(22) PCT Filed: Sep. 21, 2009
(86) PCT No.: PCT/IB2009/006691

§ 371 Date: Mar. 18, 2011

(30) Foreign Application Priority Data
Sep. 17, 2008 (NZ) 571286

(51) Int. Cl. G02C 5/08

(52) U.S. Cl. 351/63

(57) ABSTRACT

An arrangement for, but not limited to, a built-in or mounted eyewear nose-bridge, to allow folded and unfolded positions of two bodies or three bodies wherein one of them is the connecting body of the other two, in which those positions are independently locked by the force of a compression spring or by the magnetic attraction of at least two magnets or a combination of both forces. Particularly useful for sun, vision correction, sports and safety eyewear, and the like, either framed or un-framed, for adults and for children, wherein the lenses or lenses frames can fold vertically and/or horizontally in order to take full advantage of the use of a flexible temple in the eyewear.

### TECHNICAL FIELD

The invention, although useful for further purposes, is intended for eyewear of all types (e.g. eyeglasses, safety-eyewear, sports-eyewear and the like) to obtain a foldable nose-bridge enabling the user to fold and to unfold the eyewear, horizontally and/or vertically, allowing the nose-bridge to fold when not in use and to unfold locking the position when in use, independently of the temples.

### BACKGROUND ART

Prior art has been using foldable eyewear for a long time. Normally the folding is obtained through a butt hinge properly located on the nose-bridge to join both lenses or lenses frames, with the rigid temples—when in use—locking the hinge into the desired unfolded position while harnessing the user's head over the ears. In IPONZ application 554357 the temples invented being flexible do not provide this feature. The present invention allows folding-unfolding and locking into either the unfolded or folded position independently of the type of temples used to harness the eyewear to the user's head.

Mechanisms somehow similar to the invention have been used to join mostly two moving parts and eventually lock them into the desired position. For instance, a lens or it's frame to a rigid temple, a door to a doorframe, normally joining one part or body to another part or body. However none of those prior art hinges are suitable to join two lenses or lenses frames in order to allow folding and unfolding positions of both lenses at the same time, since in this case there are not two but at least three moving parts or bodies to join: the hinge, a right lens or lens-frame and a left lens or lens-frame.

### DISCLOSURE OF THE INVENTION

The invention can be made of any suitable material like metal, plastic, etc. It can be a separate unit connecting the two other bodies—lenses or lenses frames—or it may be totally or partially built-in the connected bodies.

The locking bridge embodiments use spring mechanisms as well as butt mechanisms, the last with magnets duly located to lock themselves together. It allows two positions (folded-unfolded) when a proper force is exercised on the connected bodies.

The movement may be horizontal: outwards or inwards; and vertical: normally upwards. The design may fix the connected bodies into only a one way folding-unfolding movement or allow more.

The spring mechanism has either one or two hollow bodies in which a compression spring is located.

When one hollow body or tube is used, each open end is perforated to securely locate the moving part connecting segment with an axial screw or rivet, or by properly wiring it. If wire is used it can be bent further to protect the tube end sides and duly curled to contain the eyewear nose pads.

When two hollow bodies are used, the open ends are also perforated to securely locate a connecting segment with an axial screw or rivet to unite both. The moving parts are joined to the hollow bodies' blind ends in whatever suitable way like screwing, welding, inserting, etc.

In both cases the joints are designed to allow the folding-unfolding positions, either by properly carving the needed convex spots to place a hard ball or by properly shaping the meeting ends with adequate material to stop the movement in the desired locking positions.

The butt mechanism uses a normal butt hinge with a rivet or screw in the central shaft or else a longer body with shafts at the ends to further separate the connected bodies if need be due to their size or curvature. The connected bodies have magnets properly located to lock themselves together into the unfolded in-use position.

In some cases the combination of the spring hinge mechanism and the locking magnets duly located may be convenient.

### BRIEF DESCRIPTION OF THE DRAWINGS

FIG. 1 has a central hollow (tubular or other) body (1a) containing a compression spring (1b) suitably tipped at the outer ends (1d), with the outer ends of said central hollow body suitably shaped to guide and stop the movement and be pivotally connected and secured by a rivet or screw (1e) to two terminals (1c), one at each end, in such a way that these terminals, with inner ends shaped correspondingly to the hollow body outer ends, behave as moving parts and connecting two separate bodies (1f) allow them to move and lock into the folded-unfolded positions.

FIG. 2 has two hollow (tubular or other) bodies (2a) located at the ends of the hinge with duly shaped inner ends and a compression spring (2b) inside suitably tipped (2c) at the inner ends; a central piece (2d) with correspondingly shaped outer ends to be pivotally connected and secured by a rivet or screw (2e) to the said hollow bodies that will behave as moving parts and connect two separate bodies (2f) allowing them to move and lock into the folded-unfolded positions.

FIG. 3 has a butt hinge (3a) connecting two moving bodies (3b) with at least two magnets (3c), one in each moving body, duly located to firmly attract each other and lock the bodies into the desired in-use position.

FIG. 4 is a quite similar embodiment to FIG. 4 but differs on the design of the joint that in this case are built with a hard ball (4c) that accommodates to the carved spots (4g) in folding and unfolding. The hollow body (4a) contains a compression spring ((4b) and is perforated (4e) to be joined to the connected bodies (4d) with a wire (4i) duly bent and curled to place the nose pads (4k). There are holes (4h) for screwing the lenses (4j).

FIG. 5 has a connecting body (5a) that runs in a furrow (5c) carved in the lenses (5a) that lock in the unfolded position by the attraction of two magnets (5b).

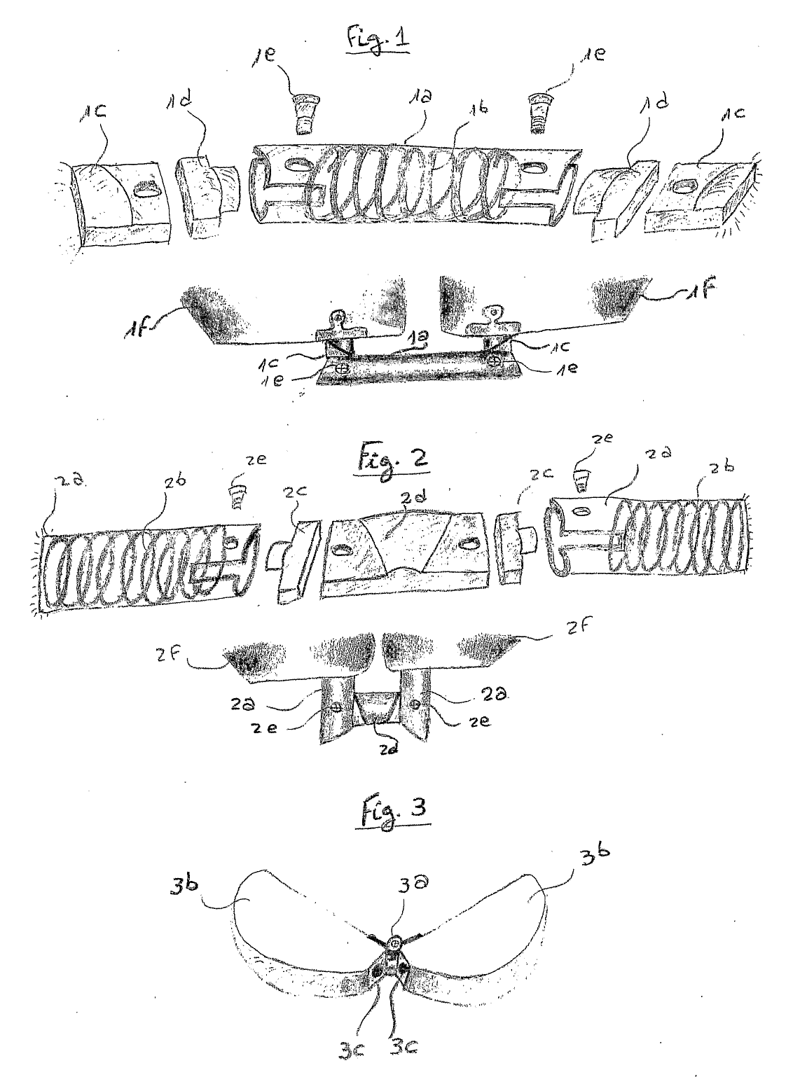

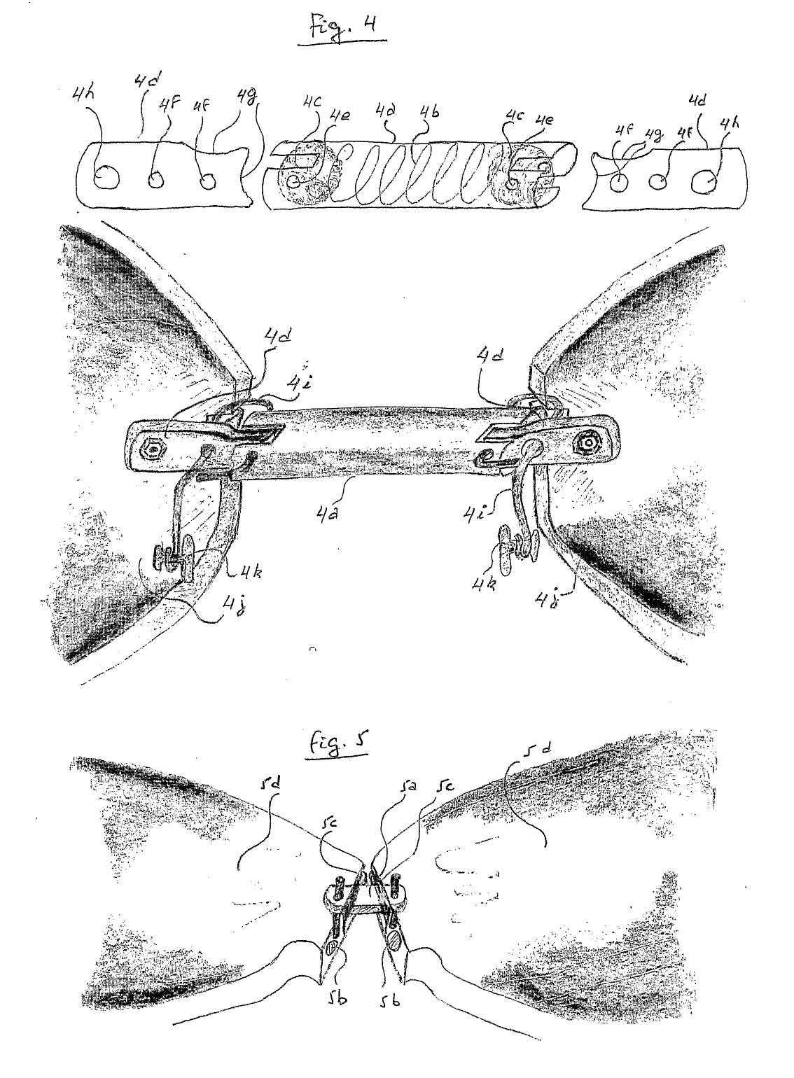

### BEST MODE FOR CARRYING OUT THE INVENTION

The preferred embodiment will depend on the size and weight of the eyewear.

Lighter frameless reading glasses may be conveniently built with the one spring mechanism.

Robust safety and sports goggles may be conveniently built with either the two spring hinge mechanism or the butt hinge and magnets mechanism or a combination of both.

What is claimed is:

1. An arrangement for, but not limited to, a built-in or mounted eyewear nose-bridge, to fold and to unfold, vertically and/or horizontally, three bodies wherein at least one of them is hollow with a compression spring inside, joining the other two at the ends with rivets or screws on duly located axial shafts; wherein the folded and unfolded positions are locked by the force of the compression spring acting at both connections by properly carving the needed convex spots to place a hard ball or by properly shaping the meeting ends with adequate material to stop the movement in the desired locking positions.

2. The arrangement of claim 1 characterized in that the connections at the joints are made with adequate wire wherein the wire used is inserted as a shaft and bent further to protect the hollow body end sides and duly curled to hold the nose pads of an eyewear.

3. An arrangement for, but not limited to, a built-in or mounted eyewear nose-bridge, to fold and to unfold, vertically and/or horizontally, three bodies wherein two of them are at least partially hollow with a compression spring inside, joining at their open ends to a connecting body with duly located shafts; wherein the folded and unfolded positions are locked by the force of the compression spring acting at both connections by properly carving the needed convex spots to place a hard ball or by properly shaping the meeting ends with adequate material to stop the movement in the desired locking positions.

4. The arrangement of claim 3 characterized in that the connected bodies, be they lenses or lenses frames, are joined to the hollow bodies blind ends in any suitable way like screwing, welding, inserting and the like.

5. An arrangement for, but not limited to, a built-in or mounted eyewear nose-bridge, to fold and to unfold, vertically and/or horizontally, three bodies wherein the connecting body has duly shaped ends for pivotal connections with axial shafts, wherein the unfolded position is locked by the magnetic attraction of at least two magnets duly located on the connected bodies.

6. An arrangement for, but not limited to, a built-in or mounted eyewear nose-bridge, to fold and to unfold, vertically or horizontally, two bodies wherein both are joined by a butt hinge with a central shaft and the unfolded position is locked by the magnetic attraction of at least two magnets duly located.

7. An arrangement for, but not limited to, a built-in or mounted eyewear nose-bridge, to fold and to unfold, vertically and/or horizontally, three bodies wherein the folded position is locked by the force of a compression spring acting inside the connecting body and the unfolded position is locked in combination of the force of the compression spring and the magnetic attraction of at least two magnets duly located on the connected bodies.
